(19) United States
(12) Patent Application Publication
(10) Pub. No.: US 2008/0264118 A1
(43) Pub. Date: Oct. 30, 2008

(54) CB radio mount screw lock

(76) Inventor: Michael Aaron King, Auburndale, FL (US)

Correspondence Address: MICHAEL AARON KING, P.O. BOX 334, AUBURNDALE, FL, 33823, US

(21) Appl. No.: 11/796,701

(22) Filed: Apr. 30, 2007

(51) Int. Cl. E05B 73/00

(52) U.S. Cl. 70/58

(57) ABSTRACT

The invention is a portable steel lock that covers over each individual mount screw. These screws are attached to a metal bracket that secures a communications radio in an vehicle.

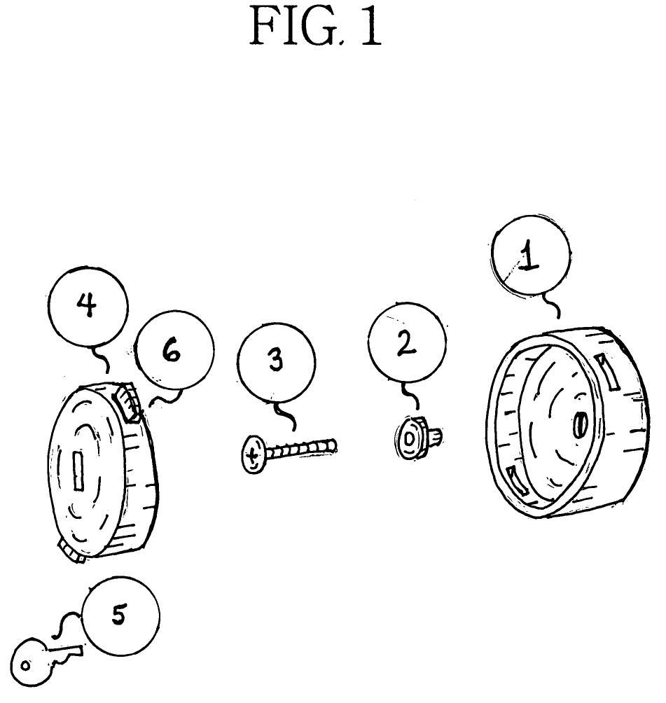

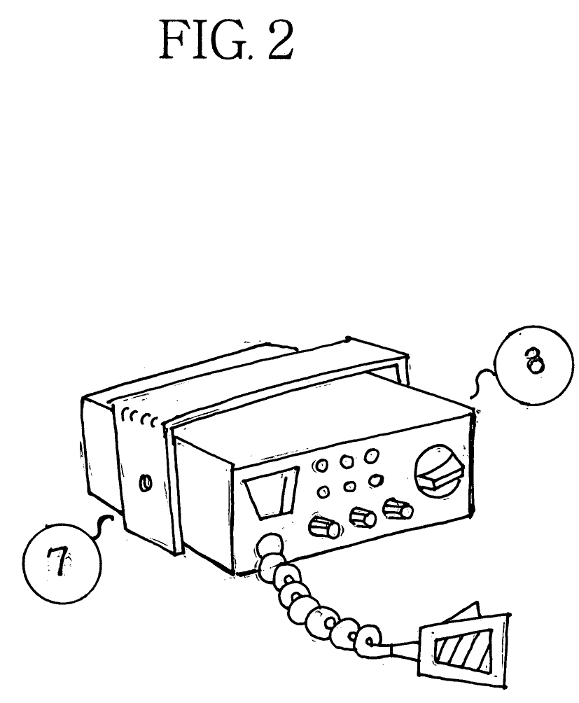

The embodiment of the present invention is illustrated in FIG. 1 and its preferred usage application is in FIG. 2. Both illustrations are diagonal views. The material of the lock assembly is steel and brass. The barrel 1 is the housing for the assembly. The back end of the barrel is applied directly to a bracket 7 in drawing FIG. 2. The barrel center hole is aligned to a bracket mounting screw hole. The swivel washer 2 is inserted into the barrel hole. The mounting screw 3 is inserted through the rotating washer and through the barrel. The screw proceeds into the bracket mounting hole and then into the CB radio 8 in drawing FIG. 2. The purpose of this rotating washer is that a thief may attempt to turn the barrel housing to see if he could loosen the mounting screw. The swivel washer allows the barrel to rotate. The rotating washer inside the barrel remains stationary with the mounting screw. The plug lock 4 is installed into the barrel. A key 5 is installed into the key hole in the plug lock. The key locks the lock plug to the barrel by two protruding pins 6. The pins extend into the slots in the barrel housing. The thief can no longer access the head of the mounting screw to remove the mounting screw when the lock plug is installed in the barrel.

### PARTS IN THE SPECIFICATIONS

1 barrel
2 rotating washer
3 mount screw
4 lock plug
5 key
6 pins
7 bracket
8 CB radio

1) A portable lock that covers over an individual mount screw that prevents a screw from being unscrewed by unauthorized personnel.

2) A portable lock for a mobile radio bracket mount screw.
